(19) United States
(12) Patent Application Publication
(10) Pub. No.: US 2018/0081504 A1
(43) Pub. Date: Mar. 22, 2018

(54) METHOD FOR THE GRAPHICAL OUTPUT OF SCREEN CONTENTS

(71) Applicant: E3 SKILLWARE GMBH SOFTWARE FOR HUMAN RESOURCES, 13507 Berlin (DE)

(72) Inventor: Michael Thomas, Berlin (DE)

(73) Assignee: E3 SKILLWARE GMBH SOFTWARE FOR HUMAN RESOURCES, 13507 Berlin (DE)

(21) Appl. No.: 15/563,355

(22) PCT Filed: Mar. 22, 2016
(86) PCT No.: PCT/DE2016/100134

§ 371 Date: Sep. 29, 2017

(30) Foreign Application Priority Data
Apr. 2, 2015 (DE) 10 2015 004 364.1

(51) Int. Cl. G06F 3/0482; G06F 3/0484

(52) U.S. Cl. CPC G06F 3/0482; G06F 19/3406; G06F 2203/04803; G06F 3/0484

(57) ABSTRACT

In a method for graphical output of screen contents for compiling a test inventory for psychological testing procedures on a graphical user interface of a computer, one or more groups of one or more user-defined test elements and predefined test elements are provided, with the user-defined test elements and predefined test elements being available for selection and assignable to the test inventory. User-defined image elements are assigned to the user-defined test elements, and predefined image elements are assigned to the predefined test elements, wherein the user-defined image elements are optically distinguishable from the predefined image elements. An input function assigns user-defined test elements and predefined test elements to the test inventory, and the user-defined image elements and predefined image elements are graphically displayed on the graphical user interface. User-defined test elements and predefined test elements are selected and assigned to the test inventory via the input function.

The invention relates to a method for the graphic output of screen contents on a graphical user interface of a computer for the compilation of a psychological testing procedure having the features mentioned in the preamble of claim 1.

Various systems for automating a selection process of candidates are already known within the framework of staff recruiting.

U.S. Pat. No. 8,046,251 B2 describes a system or a method for electronic candidate suitability measurement, wherein certain elements of an application are compiled in a position description. Elements which were identified as ineffective can be removed from the position description. However, new elements can also be added to the position description. The new elements can be tested by the user and, if necessary, removed again if they prove to be ineffective. Furthermore, a certain individualization and development of the position description is possible, with the aid of which the system remains usable and effective even during changes over a certain period of the position description. A psychological testing procedure can, for example, be one of the elements constituting a position description. However, this system is based on the disadvantage that although the elements of a position description can be compiled individually, but not the elements themselves. The psychological testing procedures placed in these position descriptions are accordingly not adapted to the position and its requirements. The option to compile the testing procedure from predefined elements and elements self-defined by the user is missing.

US 2008 009 1455 A1 proposes a web-based system for the collection and evaluation of applicants and their applications. The data is collected using a form. Classification is based on specific criteria. Modular elements can be added or omitted as required by the user. If inputs are to be made in continuous text, an evaluation module is described that supports the assessment of these responses. Depending on the position to be occupied, the scope can be adapted or other functionalities can be incorporated. The questionnaire can be sent by fax or by post and is then loaded into the system by scanning it in. It is also possible to use an on-line form, wherein files can also be loaded electronically into the system. This system is disadvantageous, however, in that the information about an applicant can be individually compiled, but individualized statements about the skills of the applicant are not available or cannot be determined. Psychological testing procedures can represent part of the information. However, they are not configurable and are therefore not adapted to the requirements profile.

A method is described in US 2011 016 1139 A1 in which personnel development opportunities and measures of structures or organizational units are analyzed and assessed. First of all, for this purpose, the abilities or combinations of abilities required for these structure or organizational units are analyzed at the respective positions. These profiles are then compared to the abilities or combinations of abilities of the current employees, and the gaps are determined from the need for abilities or combinations of abilities versus present abilities, which are recorded in a report. From this, plans for further development measures are generated and, if necessary, executed. Employee abilities are determined using a testing procedure. All the abilities of an employee relevant to the respective position are assessed here. Different methods for their analysis can be used to determine the abilities. This includes interviews, psychometric tests, group work, role playing, or on-line-based testing procedures. One or more abilities can be assessed in a method for determining abilities. The abilities can also be subjected to analysis several times, for example in an interview or an on-line test. Each test of an ability is evaluated by one or more assessors. For psychometric tests performed on-line or based on computer, the analysis can also be generated automatically.

A system and a method for an automated skill assessment are presented in US 2011 011 1383 A1. The system is constructed of a data center that manages the interface to users of the system, in which standardized questions are stored, a knowledge center that is configured to generate a test from the standardized questions stored in the data center, an analysis machine, which evaluates the responses of the candidates and a test center on which the tests are performed. The questions stored in the data center are categorized and organized with regard to different knowledge areas and skills. The questions are compiled in the skill center in a question form. With the aid of the question form, candidates can then be selected based on their abilities or combination of abilities. The system also offers other services related to the digitized placement process. Customers can select the complete system or even parts thereof in the data center. Also, it is only possible to use standardized questions for a test with this system. These also cover several abilities, but an individualized configuration of the tests adapted to the respective job profile, which can be specified by the customer himself, is also not possible with this system. It is also impossible for parts of the standardized questions to be replaced or supplemented by individualized questions.

It is therefore the object of the invention to provide a method for the graphical output of screen contents for the compilation of a psychological testing procedure on a graphical user interface of a computer, which makes it possible to distinguish the predefined test elements from the test elements defined by the user,

This object is achieved according to the invention by a method which comprises providing predefined test elements for assessing skills, providing an input option for the definition of user-defined test elements, and providing the user-defined test elements for assignment to a test inventory.

The method according to the invention is used for the graphical output of screen contents for the compilation of a test inventory for psychological testing procedures on a graphical user interface of a computer. In the future, psychological testing procedures will be largely automated. For this purpose, the test inventories are created partially or fully automated via publicly accessible networks, to which candidates are sent and, if possible, evaluated at the same time. In the present method, an input function is initially provided for the definition of user-defined test inventories, wherein test elements can be assigned to a user-defined test inventory using the input function. This has the advantage that a user can create customized test inventories tailored to his own needs, which may be later a part of a psychological testing procedure. Many companies already have test inventories that they have used for years to analyze skills of employees or candidates. Without the possibility to continue relying on these user-defined test inventories, comparability would no longer be possible between results from testing procedures performed earlier and results determined using the newly automated testing procedures. Furthermore, in the method according to the invention, predefined test inventories are available for selection for a test inventory. The present method is thus both suitable for compiling test inventories exclusively from predefined test elements which can be used by companies which have not created their own test elements in the past or have consistently relied on changing test elements. The predefined test elements are usually stored with extensive empirical data and thus enable high-quality information. However, test inventories can also be compiled from predefined and user-defined test elements, thus combining the advantages of both groups of test elements. In a next step of the method according to the invention, image elements for the selection of one or more test elements from one or more groups of test elements are graphically output to a user interface, wherein one or more test elements are assignable to a test inventory. Each test inventory can be individually compiled and saved. In the present invention, the test elements, which are assigned to a test inventory, can be selected from a plurality of groups of test elements. The test elements can be selected from the group of predefined test elements and/or the group of user-defined test elements. For this purpose, the test elements available for selection are displayed by means of image elements on a graphical user interface. The image elements may include characters for identification, wherein the image elements of the user-defined test elements available for selection are optically distinguishable from the image elements of the predefined test elements available for selection. Due to the fact that not only predefined test elements are displayed for selection, but rather user-specific test elements are presented, there is the possibility that several test elements for a skill such as, for example, staff management, are available for selection in the test inventory and must be displayed. Since, in particular, different employees may be involved in the test inventory compilation in large companies and are to use the user-defined test elements of their colleagues, it is advantageous to select the optical representation of the test elements available for selection so that, for each employee, it is recognizable at first glance which test elements are the predefined test elements and which test elements are the user-defined test elements.

Further refinements of the invention result from the subclaims.

In a further embodiment of the method according to the invention, the screen contents can be displayed on a computer connected to a publicly accessible network. This has the advantage of being able to access the predefined test elements and the possibility of creating user-defined test elements. In further optional embodiments of the invention, the present method is embedded in a method for the automated execution of psychological testing procedures. In this case, the test user is provided with access to a central service unit via a publicly accessible network. One or more programs for the automated creation of a test form and control of communication between the test user, the test candidate and the central server unit run on the central server unit. A program provides the user with predefined test elements for selection in a test inventory. Another program offers the test user an editor function for the definition of user-defined test inventories. These are stored on the central server unit after the creation of the user-defined test elements. Both user-defined test elements and predefined test elements are then presented to the test user on a graphical user interface for selection into a test inventory. After selecting the test elements for a test inventory, the test inventory is stored on the central server unit. The test user is then provided with a selection of test candidates in which environment the test user can assign one or more test candidates to one or more test inventories. After the send command is issued, a test form is automatically created which contains the items assigned to the selected test elements, and access information is sent to the selected test candidate, with the aid of which the test candidate can process the items of the psychological test. This access information may include, for example, a link to a website on which the items are provided for the test candidate to answer. You can also provide login information which enables the test candidate to access a secure environment. The items to be answered are provided to the test candidate in the environment. After the test candidate finishes answering the items, the results are stored on the central server unit and a notification of the completed procedure is sent to the test user. In optional embodiments, the results can then be provided to the test user for review, or the results are evaluated automatically and summarized in a report, which is then provided to the test user. The test results are provided by sending a document or by providing access to the test results via a public network.

In a further embodiment of the invention, the screen contents are displayed using a web browser. The method according to the invention enables a test user, who has, for example, created his own test element for assessing a certain test skill of a test candidate, by means of a publicly accessible network in a web-browser-based environment, in an automated method for generating a psychological test form, to easily distinguish this user-defined test element from a predefined test element for assessing the overall skill of the test candidate without making use of the definition of one or both of these test elements.

In a further preferred embodiment, the group of user-defined test elements available for selection and the group of predefined test elements made available for selection are displayed in two different and separate display areas. The display areas have highlighted label areas which additionally indicate the origin of the contents of the display area.

In a particularly preferred embodiment of the invention, the separate display area is displayed on a separate website. On an upstream web page, the test user is provided a separate selection option for both groups of test elements, which are each linked to a separate website, on which the test elements of a group are then made available for selection for a test inventory. It is impossible to confuse the test user because of the clear structural separation of the display areas.

In a preferred embodiment of the invention, the separate display area for the predefined test elements and the user-defined test elements is shown in a respective pop-up window. A pop-up window has the advantage that parts of the website still remain visible and only a few parts of the original page are hidden by the pop-up window. For example, the area in which the selected test elements are displayed can remain visible. This allows the test user to directly reconstruct which test elements are selected. In a variant of this exemplary embodiment, the respective test elements are displayed in separate push-down menus for selection to a test inventory.

In a further development of the invention, the separate display area is labeled, wherein the label contains an indication that the test elements shown are assigned to one of the groups of the predefined test elements or of the user-defined test elements. The labeling has the advantage that the test user is already informed of the content of the test elements provided for selection by means of the labeling. In an optional embodiment of the invention, the label can be defined by the test user, This has the advantage that the test user can individually display the groups of the test elements available for selection.

In a further advantageous embodiment of the present invention, the graphical outputs of the user-selected test elements available for selection and the predefined test elements available for selection are distinguished by a different label. In this case, the labeling includes characters, which in turn provide an indication of the origin of the test element. These characters can, for example, be the business abbreviation of the test user's company. The predefined test elements can be supplemented by the characters “predef.” or similar character strings which indicate whether the test element is assigned to the group of predefined test elements or the group of user-defined test elements. Further character strings are conceivable and freely designable. In an alternative embodiment of the invention, the character strings of the actual label of the test element are placed ahead or behind. In an further development, the character string is separated from the label by a delimiter. One or more characters from the group “/”, “-”, “|”, “#” or even other characters can be selected as separators. Furthermore, a two-line design of the label can be selected in which the label is arranged in the one line and the character string is arranged in the other line.

In a further development of the invention, different fonts for the labeling of the test elements are used for the graphical output of the user-defined test elements available for selection and the graphical output of the predefined test elements available for selection. In a preferred embodiment of the invention, the fonts differ for the labeling of the user-defined test elements and the predefined test elements by the use of different font types, font sizes and/or font colors. In a preferred embodiment, the corporate identity font of the test user's company is used for the user-defined test elements. Further distinctions are possible with bold, italic, underline or other features. The advantage of this development of the invention lies in the fact that all test elements available for selection for a test inventory can be displayed in a list, but however, it can be recognized at first glance whether it is a predefined test element or a user-defined test element.

In a particularly preferred further development of the invention, the graphical output of the user-defined test elements available for selection and the graphical output of the predefined test elements available for selection are stored with different colors. Thus, it is recognizable at first glance which type of test element is involved in the displayed tests. In a particularly preferred embodiment, the color of the corporate identity of the test provider is used as the background color for the predefined test elements. In a further preferred embodiment of the invention, the color of the corporate identity of the company of the test user is used for the background color of the user-defined test elements.

In a further preferred development of the invention, different image elements are assigned to the test elements to optically distinguish the graphic output of the user-defined test elements available for selection and the graphical output of the predefined test elements available for selection. This preserves both the clarity of the graphical representation and the distinctness of the predefined test elements from the user-defined test elements. In a particularly preferred embodiment of the invention, the image elements assigned to the user-defined test elements have a reference to the company of the test user. One possible embodiment is the use of the company logo as a supplementary image element for a user-defined test element of the test user. In a further particularly preferred embodiment of the invention, the image element, which is assigned to the graphical output of the predefined test elements available for selection, has a reference to the company of the test provider.

A further embodiment of the invention provides that the graphic output of the user-selected test elements available for selection can be optically distinguished from the graphical output of the predefined test elements available for selection by means of animated image contents.

The term items refers to statements, questions or tasks which test candidates answer as part of a test execution. A distinction is made here between different types of items.

The group of items includes those that are assigned to individual skills. These are all items that are used at any point in time in any skill (and thus also test). If a test candidate undertakes a test, these items appear in the test.

There are also distractors. Distractors are items that are not assigned to a skill. They serve exclusively to make the test more non-transparent to the test candidates. Distractors can then be included in a test if there is an insufficient number of items, e.g., because the test user has selected too few skills for his test form.

In addition, items are used to measure the tendency to represent one's self in an overly positive manner. These are items from the so-called “lie scale” or the scale of social desirability. The items of the lie scale are added as standard to each test, no matter how long or short it is.

Another type of items is items “under construction”. These are items that have not yet been empirically validated, and for which empirical data are collected to either construct new skills or improve the measurement of skills through “better” items. Like the distractors, these items can be included in a test whenever there is an insufficient number of items, for example because the test user has too few skills in his test.

The compilation of individual items for the measurement of defined psychological constructs (methodical, personal and social skills) for a test candidate is called a test element or also a skill. A test element or skill is usually measured by answering 4-12 items. The term test element or skill is used analogously to the term test.

A user-defined test element in the sense of the invention is a test element which is specified by the test user in his compilation. The specification can include the selection of individual items or even a skill, not previously defined, for which a new test element must be created. The creation of a new test element can be carried out by the operator of the platform himself. This has the advantage that the operator ensures that the quality requirements are maintained in the test elements available for selection, since he can carry out the empirical validation himself and offer the user-defined test element in an optimized compilation. Furthermore, it is possible that the test user can completely freely compile his test elements himself. For this purpose, an input option is made available to the test user, with the aid of which the test element is defined.

The compilation of individual skills for performance in a test candidate is known as a test inventory. A test inventory usually includes between three and 15 skills. A test user in the sense of the patent is a person or organization that performs a psychological test on a candidate in order to obtain a well-founded statement about the skills of the candidate. This may be in the context of a recruitment procedure or a staff assessment or in the case of personnel development measures or similar events.

A test candidate may, for example, be an employee of a company or department whose skills are determined by a personnel appraisal, or it can be an advertisement for a position to be filled, the skills of which are to be assessed.

The invention is explained in more detail below with reference to a number of exemplary embodiments. Shown are:

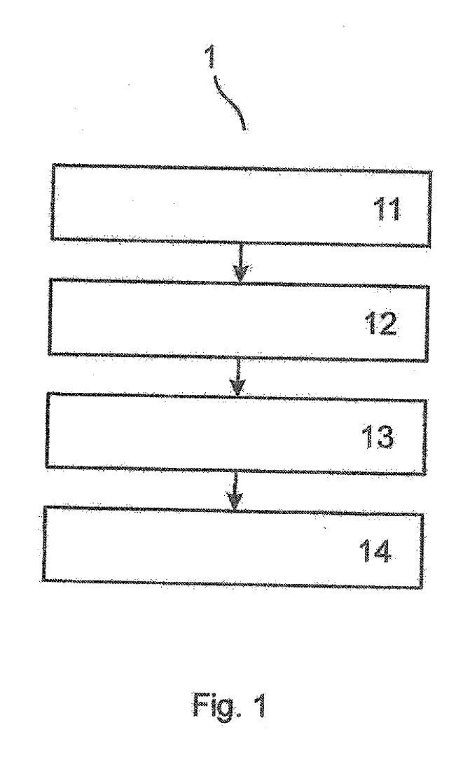

FIG. 1 a method for graphically outputting screen contents for a psychological testing procedure on a graphical user interface of a computer,

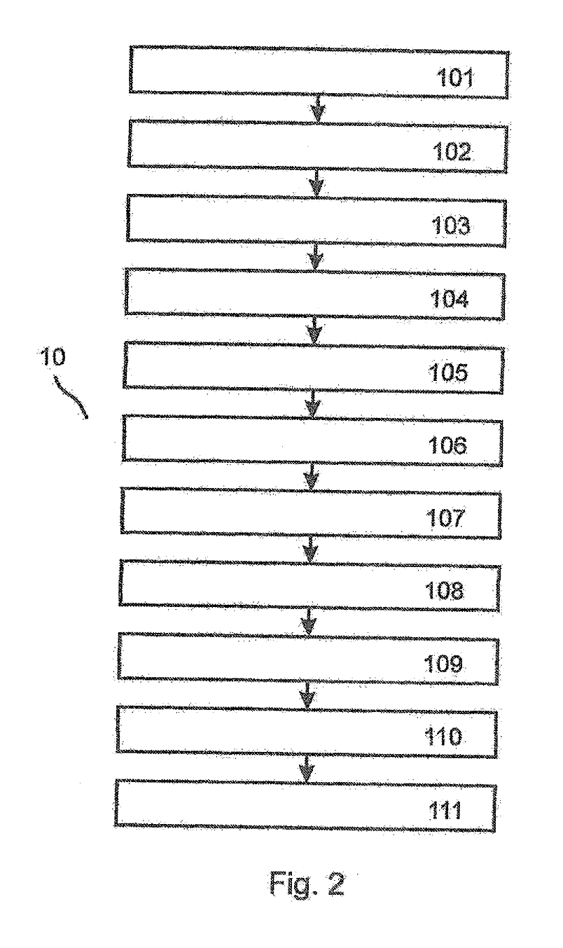

FIG. 2 a method for graphically outputting screen contents for a psychological testing procedure on a graphical user interface of a computer, embedded in a method for generating and performing a psychological testing procedure,

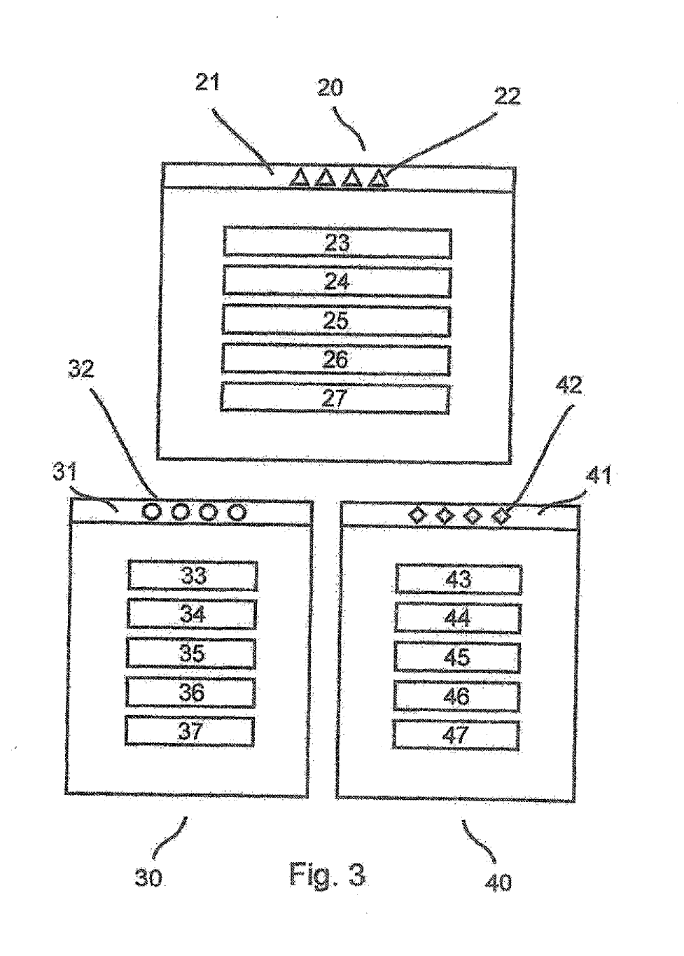

FIG. 3 a graphical representation of the user-defined and predefined test elements available for selection into a separate display area for distinguishing the user-defined and predefined test elements,

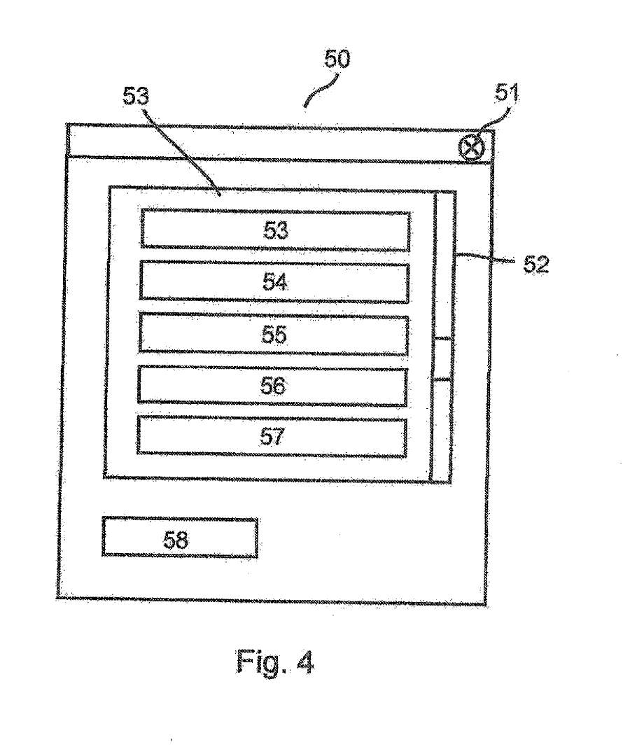

FIG. 4 a graphical representation of test elements available for selection in a separate pop-up window,

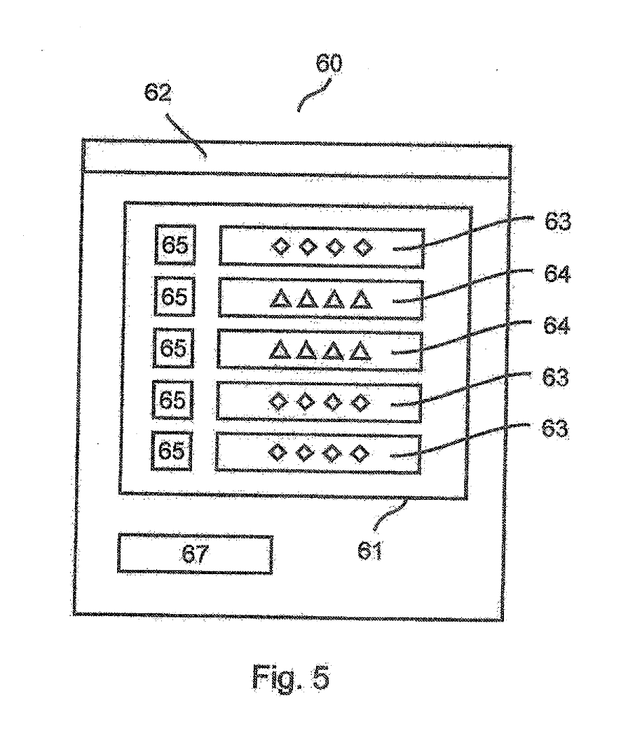

FIG. 5 a graphical representation of the test elements available for selection in a common list with different labels for distinguishing the user-defined and predefined test elements,

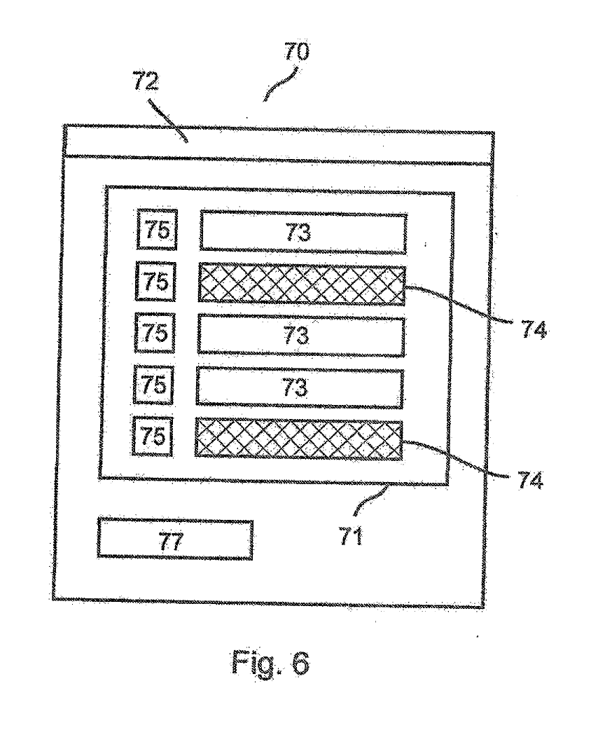

FIG. 6 a graphical representation of the test elements available for selection in a common list with different colors for distinguishing the user-defined and predefined test elements,

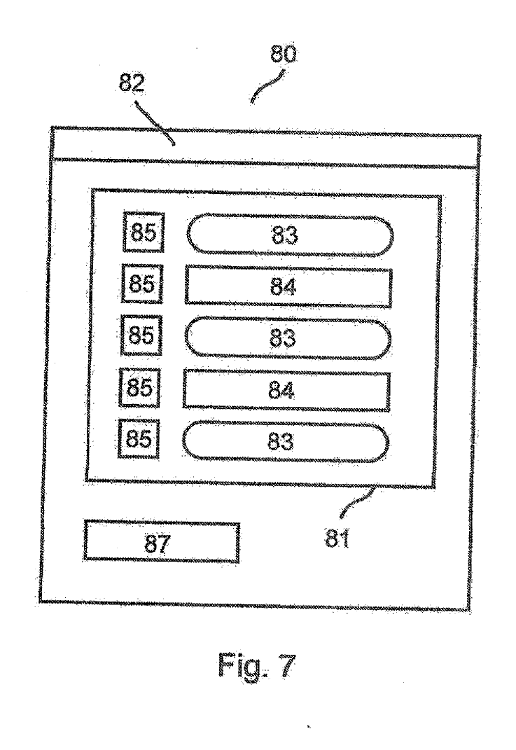

FIG. 7 a graphical representation of the test elements available for selection in a common list with different forms for distinguishing the user-defined and predefined test elements,

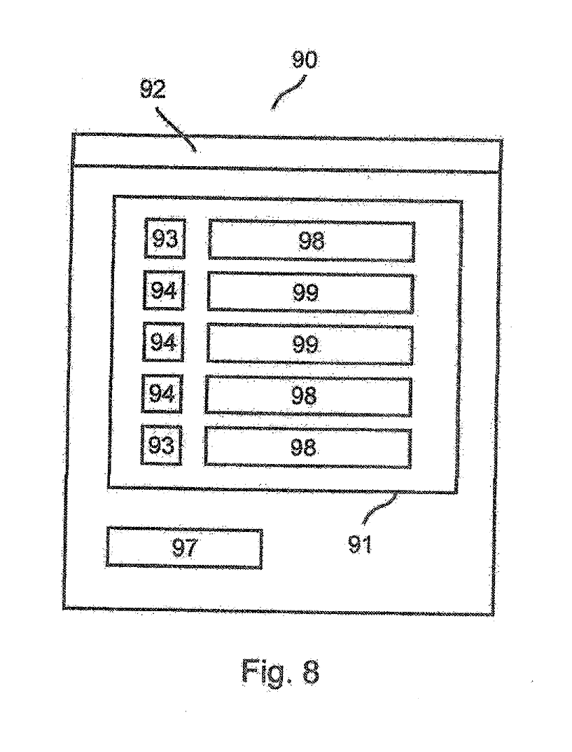

FIG. 8 a graphical representation of the test elements available for selection in a common list with additional graphical symbols for distinguishing the user-defined and predefined test elements.

FIG. 1 shows the method steps of the method 1 according to the invention for the graphical output of screen contents for the compilation of a test inventory for psychological testing procedures on a graphical user interface of a computer in which the test user is provided both with predefined test elements available for selection as well as the option of being able to select user-defined test elements for the test inventory. In the present method 1 according to the invention, the image elements of the predefined test elements, which are displayed for selection for a test inventory, are displayed to the user for selection to a test inventory 11. The display is, for example, via a list display, in which the predefined test elements available for selection are listed according to their designation. Other representations are also included according to the invention. Typically, the name of the test element gives an indication of the skill to be analyzed using the test element. In an alternative development of this exemplary embodiment, further information about the selected test element are output via the selection of the predefined test element. This information includes, for example, the items assigned to the test element, or the characteristics that describe the quality of the test element. This includes one or more specifications on the size of the standard that was based on empirical validation and/or on values for reliability, validity, content validity, criterion validity, difficulty or discriminating power. Reliability refers to the measuring accuracy of a test element or skill. Validity is a measure of how well the measured values of a skill or item actually represent the variable to be measured. Different validity types are distinguished: Content validity, construct validity, and criterion validity. Content validity is assumed when a method for measuring a particular construct or feature is the best possible operationalization of this construct. Construct validity is present when the scope of meaning of the construct is represented in a complete, precise and comprehensible manner. Criterion validity refers to the relationship between the results of the measurement instrument (skill) and an empirical criterion. One differentiates the concurrent validity (the measuring instrument and the criterion are collected at the same time) and the prediction validity (the data of the measuring instrument are collected before the criterion is collected). The difficulty of an item is the proportion of those who solve or affirm the item correctly. The purpose of the difficulty index is the differentiation of test candidates with higher and with lower expression of a skill. The discriminatory power of an item is the correlation of the item with the overall result of a skill.

A further method step comprises the display of the image elements of the user-defined test elements 12, which are displayed for selection for a test inventory. The user-defined test elements available for selection are also displayed in a list. These user-defined test elements allow a test user to create his own test elements. These user-defined test elements may, for example, comprise new test elements that are not already represented by predefined test elements. However, it is also possible to define test elements which are already predefined but do not meet the requirements of the test user. This can be the case if the test user's user-defined test elements have already been used by the test user for a long time and a comparability of the newly obtained results is to also be ensured with the results of previous psychological tests. Furthermore, one reason for considering the user-defined creation of test elements may be that the empirical validation of the user-defined test element appears to be more appropriate with another position to be possibly filled or evaluated. Since many skills are already present among the predefined test elements, it is very likely that the same or at least similar sounding terms for the designation of the user-defined test elements are selected as they have already been used for the predefined test elements. Since this can then lead to confusion between predefined and user-defined test elements, according to the invention, the image elements of the predefined test elements available for selection are optically distinguishable from the image elements of the user-defined test elements available for selection. Due to the additional optical distinctiveness of the two groups of test elements, a confusion in the selection and assignment of a test element to a test inventory is impossible because the test user can also immediately distinguish between an image element for a predefined test element and an image element for a user-defined test element if he has not created the user-defined test element itself.

In another method step, an input option for the user-defined definition of test inventories 13 is provided. The test elements can be individually assigned to the user-defined test inventory via an input mask. Furthermore, the input option can include providing a function by the aid of which test inventories can be loaded. The provision of the input option for the definition of the test inventories by the test user may comprise one of the above-mentioned options or represent a combination of the above-mentioned options. Additions to the above-mentioned input options are also included in the inventive concept. Finally, the test elements selected by the test user are assigned to his test inventory 14 and the newly defined test inventories are stored on a central server unit.

In a preferred further development of the invention according to the exemplary embodiment according to FIG. 1, the screen contents for the selection of the predefined and the user-defined test elements are displayed on a computer connected to a public network, such as the Internet. In a particularly preferred embodiment of the invention, the screen contents can be displayed using a web browser. This has the advantage that standard computers and standard hardware already available today can be used to perform the process.

FIG. 2 shows a further embodiment of the sequence of the method for the graphical output of screen contents for the compilation of a test inventory for psychological testing procedures on a graphical user interface of a computer with additional optional method steps 10, wherein each of the additional method steps can optionally be integrated individually into the method sequence of the method described in FIG. 1.

Compared to the method sequence shown in FIG. 1 with the method steps, displaying of the predefined test elements 11, displaying of the user-defined test elements 12, providing an input function for assigning the test elements available for selection to a test inventory 13 and assignment of the selected test elements to a test inventory 14, in a further optional method step, access to a server system 101 is provided, on which a computer program runs for the partially or fully automated creation and/or execution of a psychological testing procedure. This access is achieved via an interface that is connected to a network. This can be a publicly accessible network, such as the Internet, or even any other network. In a further variant, the method provides access to a secured area through the approach. This allows all data to be protected against unauthorized access. These data may include, for example, the selection of the test elements, descriptions of positions requirements for job incumbents or candidates for new positions to be filled, company-specific data concerning personnel development, personal data of the test candidates, results of already performed testing procedures as raw data or also in already evaluated form, reports, data protection-relevant information or also other data collected, measured or generated in connection with the testing procedure.

In a further optional method step, a test form is generated from the selected predefined and/or user-defined test elements. By means of a storage 108, either of the selection of the test elements or of the test form, a further step is then ensured so that the selected test elements are available at a later point in time.

In a further embodiment of the method, during the generation of the test form, the items assigned to a selected test element are inserted into the test form. This can take place immediately after the selection of the test elements, after the assignment of the test candidates or even just before the test is carried out.

In a further embodiment of the invention, the test user is shown the selection for the test candidates available for selection for the performance of the psychological testing procedure 110. After the selection of one or more test candidates, the sending of invitations for the execution of a psychological testing procedure is automatically made 110. For this purpose, the test candidates are sent a message with the invitation to this testing procedure to the address stored in the personal data. The sending can be done electronically, i.e., by e-mail, by fax, by SIMS, or also by postal mail. In the case of postal delivery, the form is sent to a printer for printing. Another possibility is to send an editable file electronically.

The testing procedure can also be carried out electronically. For this purpose, the test candidates are sent access information with the invitation, with the aid of which they are given access to the computer system according to the invention. This can be done, for example, via a link copied into the invitation, or via access data, which are transmitted in test candidates in the invitation. Via this access, the test candidate then reaches the electronically provided test form. This test form can then be answered on-line and stored on the computer system.

In a further optional method step, the read-in of the answers of a test candidate is also performed automatically 111. In the case where the testing procedure has been performed and stored on-line on the computer system, or if an edited editable file is present, the responses from the stored data can be read directly from these sources. If the test form is sent by mail, the edited test form can be digitized via a reading unit. This can be done, for example, via a scanner.

In a further possible method, a selection of standards is made available to the test user for the purpose of analyzing the test data. These standards differ in the composition of the reference population. This results in a significant increase in the meaningfulness of the test result since, for example, the tested skills with the answers from a reference population which has a specialization comparable to the position to be filled or assessed. A description of the standards available for selection can also be presented. The description may include specifications on the size of the comparison group surveyed for this standard and/or other characteristics such as age, position, professional experience or the like.

An optional method step also provides for the creation of the evaluation. For this purpose, an evaluation form is created partially or fully automated. The data of the test candidate and the test user are automatically inserted into the evaluation form. The digitally available data are compared to the data of the selected standard and are transferred in evaluation graphs and automatically created text modules.

FIG. 3 shows a further embodiment of the invention in which the image elements for the selection of the predefined and user-defined test elements are shown optically distinguishable in that the image elements are displayed in respectively separate display areas 20, 30, 40. A display area is shown in the upper area of the illustration, in which the test elements assigned to a test inventory are depicted 20. The display areas of the predefined test elements 30 and of the user-defined test elements 40 are shown side by side in it. In this example, the display area of the predefined test elements 30 on the left and the display area of the user-defined test elements 40 on the right. The image elements 33, 34, 35, 36, 37, 43, 44, 45, 46, 47 of the test elements which are assigned to the respective area are arranged in the respective display areas 30, 40 of the test elements available for selection to the test inventory. In this exemplary embodiment, the display areas 20, 30, 40 have a header 21, 31, 41 with an label field 22, 32, 42. A title or a description of the respective display area is displayed in the label fields 22, 32, 42, which gives a content-related indication of the content of the display area. If a test element for the test inventory is selected from the predefined or user-defined test elements, the image element of this test element 23, 24, 25, 26, 27 is displayed in the upper display area of the test inventory. The selection of a user-defined or predefined test element can be selected, for example, by drag & drop, double-clicking or clicking and confirming on the respective image element of the test element 33, 34, 35, 36, 37, 43, 44, 45, 46, 47. In a particularly preferred embodiment, the label can be defined by the user himself.

FIG. 4 shows a pop-up window 50 in which the test elements 53, 54, 55, 56, 57 available for selection are shown. This window 50 appears when an image element for the predefined or user-defined test elements has been selected in the main window displayed in the web browser. After selecting one of the two groups of test elements, a smaller display area 50 (window), which does not fill the entire display area, opens in the foreground for the selected group, in which the image elements 53, 54, 55, 56, 57 of the test elements of the selected group are displayed. This window is provided with a scroll bar 52 as long as the image elements of the test elements 53, 54, 55, 56, 57 available for selection are not completely located in the reduced display area 50. In the pop-up window 50, the test elements available for selection can be selected and this selection can be confirmed by means of a switch 58. After confirmation, the window 50 closes again and the test user can continue to work in the main display area. In a particularly preferred embodiment of the invention, the window 50 can also be closed via a separate switch 51. Predefined and user-defined test elements are displayed in separate pop-up windows 50 after selection in the main window.

A further embodiment of the invention is illustrated in FIG. 5. In the display area for the test elements 60 available for selection, both image elements for predefined test elements and image elements for user-defined test elements are shown. In order to optically distinguish these elements immediately, a different label 63, 64 is used for predefined test elements and user-defined test elements. In a preferred embodiment, different font types are used for predefined and user-defined test elements. For example, this can be the Arial font for the predefined test elements and the Times New Roman font for the user-defined test elements. The optical distinctiveness in a further preferred embodiment of the invention can also be produced by the use of different font sizes, different font colors and/or differently inclined characters (italic). This assignment of fonts to the predefined and the user-defined test elements is explained to the test user by an indication on the display area. In a particularly preferred embodiment, the respective test elements can be marked via a separate switch 65. The selection is then confirmed by a further switch 67.

A further embodiment of the invention is shown in FIG. 6. As in FIG. 5, the image elements of the predefined test elements 73 available for selection and the image elements of the user-defined test elements 74 available for selection are shown together in a display area 70 in the form of a list 71. In order to ensure the optical distinguishability, in this embodiment of the invention, a background color which is different from the background color of the image elements of the user-defined test elements 74 available for selection is used for the image elements of the predefined test elements 73 available for selection. For example, the background color of the predefined test elements is red, while the background color of the user-defined test elements is blue. This color assignment is explained to the test user by an indication on the display area. As in FIG. 5, the respective user-defined or predefined test elements can be selected for a test inventory via a switch 75, and this selection can be confirmed via a further switch 77.

FIG. 7 shows a display region 80 for a further embodiment of the invention in which both image elements for the predefined test elements 83 available for selection as well as image elements for the user-defined test elements 84 available for selection are shown in a list 81. The selection in this example takes place via switches 85, which are individually assigned to each test element available for selection. The selection is confirmed by a separate switch 87. After confirming the selection of the test elements for a test inventory, the test elements previously selected by the test user are assigned to the test inventory. In order to distinguish the image elements of the predefined test elements 83 from the image elements of the user-defined test elements 84, the image elements for the predefined test elements 83 were assigned a different form than the image elements for the user-defined test elements 84. In the example shown in FIG. 7, the image elements for the predefined test elements 83 are provided with rounded corners. However, the image elements for the user-defined test elements 84 available for selection have right-angled corners. Further possibilities for different representation are different geometric shapes such as, for example, oval, rectangle and diamond. In a particularly preferred embodiment of the invention, the image elements for the test elements 83, 84 available for selection can be differently animated. Thus, a different animation is selected for the user-defined test elements than for the predefined test elements. The animation can include changing colors, brightness, movement, flashing, flickering, changing sizes of the image elements, or other effects.

A further particularly preferred embodiment of the invention is shown in FIG. 8. The image elements of the test elements 98, 99 available for selection are shown in a mixed list 91 in which both the image elements of the predefined test elements 98 available for selection are shown as well as the image elements of the user-defined test elements 99 available for selection. These image elements are each assigned additional image elements 93, 94, which ensures a differentiation of the predefined test elements from the user-defined test elements. For example, user-defined test elements can be assigned to circles, while squares are assigned to the predefined test elements. In a particularly preferred embodiment, symbols are used for the image elements 93, 94 additionally assigned to the respective test elements, which have a reference to the test user's company for the user-defined test elements and a reference to the test provider's company for the predefined test elements. In a particularly preferred embodiment of the invention, the respective logos of the companies are used for the symbols assigned to the respective test elements. The selection is then made by clicking on the image element 93, 94 assigned to the respective test element.

The distinguishability of the image elements of the predefined test elements 63, 73, 83, 98 available for selection from the user-selected test elements 64, 74, 84, 99 available for selection is not only important in the display area for the selection of test elements. Therefore, the different optical characteristics for the user-defined and the predefined test elements are also used in the presentation of the test elements already assigned to a test inventory. This has the advantage that the image elements of the predefined test elements 63, 73, 83, 98 and the image elements of the user-defined test elements 64, 74, 84, 99 remain distinguishable even after assignment to a test inventory.

### LIST OF REFERENCE NUMBERS

1 Method for the graphical output of screen contents
10 Method for automated creation and for automated execution of a psychological testing procedure
101 Providing access to a computer system
11, 102 Display of predefined test elements for selection for a psychological testing procedure
12, 103 Display of predefined test elements for selection for a psychological testing procedure
13, 104 Providing an input option for user-defined definition of test inventories
14, 105 Assignment of the selected test elements to a test inventory
106 Saving of user-defined test inventories
107 Generation of the test form based on the selected test elements
108 Storage of the test form and/or the selection of the test element
109 Display for the selection of the test candidates
110 Sending invitations for the test
111 Reading in the answers
20 Display area of the test elements selected for a test inventory
21, 31, 62 Highlighted area of a display area
72, 82, 92
22 Title labeling of a display area of a test inventory
23, 24, 25, Test elements assigned to a test inventory
26, 27
30 Display area of the predefined test elements
32 Title label of the display area for displaying the predefined test elements
33, 34, 35, Elements for selecting predefined test elements
36, 37
40 Display area of the user-defined test elements
42 Title label of the display area for displaying the user-defined test elements
43, 44, 45, Elements for selecting user-defined test elements
46, 47
50 Pop-up window to display test element available for selection
51 Switching element to close the pop-up window
52 Scroll bar
53, 54, 55, Elements for selecting test elements
56, 57
60, 70, 80, Display area of the test elements available for selection
90
63, 73, 83, Labeling of the display element of the predefined test element
93
64, 74, 84, Labeling of the display element of the user-defined test element
99
65, 75, 85 Switching element for selecting a test element
67, 77, 87 Switching element for storing the selection of test elements to a test inventory
97
93 Graphical symbol for the predefined test element available for selection
94 Graphical symbol for the predefined test element available for selection

What is claimed is:

1.-15. (canceled)

16. A method for the graphical output of screen contents for compiling a test inventory for psychological testing procedures on a graphical user interface of a computer, said method comprising:
providing one or more groups of one or more user-defined test elements available for selection and assignable to the test inventory;
providing one or more groups of one or more predefined test elements available for selection and assignable to the test inventory;
assigning user-defined image elements to the user-defined test elements;
assigning predefined image elements to the predefined test elements, wherein the user-defined image elements are optically distinguishable from the predefined image elements;
providing an input function for a user to define the test inventory and to assign user-defined test elements and predefined test elements to the test inventory;
defining the test inventory by the input function;
graphically displaying the user-defined image elements and predefined image elements on the graphical user interface;
selecting and assigning user-defined test elements to the test inventory via the input function; and
selecting and assigning predefined test elements to the test inventory using the input function.

17. The method of claim 16, further comprising connecting the computer to a publicly accessible network.

18. The method of claim 17, further comprising displaying the user-defined image elements and predefined image elements via a web browser.

19. The method of claim 16, wherein the user-defined image elements are displayed in a first display area that is separate from a second display area in which the predefined image elements are displayed.

20. The method of claim 19, wherein the first display area and the second display area are displayed on separate web pages.

21. The method of claim 19, wherein the first display area and the second display area are displayed in separate pop-up windows.

22. The method of claim 19, wherein the first display area has a label which indicates that the user-defined image elements represent user-defined test elements and the second display area has a label which indicates that the predefined image elements represent predefined test elements.

23. The method of claim 22, further comprising enabling the user to define the label of the first display area and the label of the second display area.

24. The method of claim 22, wherein the first display area and the second display area have different labels.

25. The method of claim 22, wherein the label of the first display area and the label of the second display area have different fonts.

26. The method of claim 22, wherein the font used in the label of the first display area and the font used in the second display area differ by the use of different font types, font sizes and/or font colors.

27. The method of claim 16, wherein the user-defined image elements are optically distinguishable from the predefined image elements by using different colors.

28. The method of claim 16, wherein the user-defined image elements are optically distinguishable from the predefined image elements available for selection by additional image elements assigned to the test elements.

29. The method of claim 28, wherein the additional image elements used for the user-defined test elements have a symbolic reference to the user.

30. The method of claim 16, wherein the user-defined image elements are optically distinguishable from the predefined image elements by animated image content.
